(19) United States
(12) Patent Application Publication
(10) Pub. No.: US 2015/0291477 A1
(43) Pub. Date: Oct. 15, 2015

(54) METHOD FOR PREPARING GRANULATED BENTONITE FORMED BODY AND GRANULATED BENTONITE FORMED BODY PREPARED THEREBY

(71) Applicant: KOREA INSTITUTE OF ENERGY RESEARCH, Daejeon (KR)

(72) Inventors: Kang Bai, Seoul (KR); Joung Son Woo, Daejeon (KR)

(21) Appl. No.: 14/432,192

(22) PCT Filed: Sep. 10, 2013
(86) PCT No.: PCT/KR2013/008146

§ 371 Date: Mar. 27, 2015

(30) Foreign Application Priority Data
Aug. 23, 2013 (KR) 10-2013-0100278
Sep. 28, 2013 (KR) 10-2012-0108516

(51) Int. Cl. C04B 28/26

(52) U.S. Cl. CPC C04B 28/26

(57) ABSTRACT

The present invention relates to a method for manufacturing granulated bentonite including adding sand, alumina or graphite to a bentonite raw material, heating the resulting mixture to 700 to 1,200° C., and grinding a bentonite molded body formed by heating to produce granules of uniform sizes.

### TECHNICAL FIELD

The present invention relates to a method for manufacturing a granulated bentonite molded body and a granulated bentonite molded body manufactured by the same.

### BACKGROUND ART

Bentonite has a property of absorbing water and swelling in itself, and is used in a water-blocking wall for civil ground works or a grout material for geothermal heat exchangers by virtue of this property. Since pure bentonite has low thermal conductivity, when it is used in geothermal fields requiring high heat transfer, various materials capable of increasing thermal conductivity may be mixed. However, if these materials are mixed in large amounts, a mixture may be separated into each material due to differences in specific gravity from the bentonite. This may causes various problems.

To improve the above-mentioned problems, various attempts have been made. For example, Korean Laid-open Patent Publication No. 2010-0060916 discloses a manufacturing method of a bentonite compacted article with high density. In this method, a dry powder of bentonite is compacted to have high density, followed by wetting with water to impart swelling pressure, and finally drying. In this case, there may be a problem in peptization property, that is, the bentonite compacted article may be easily dissociated upon wetting by water again.
(Patent Document 1) Korean Laid-open Patent Publication No. 2010-0060916

### DISCLOSURE OF THE INVENTION

### Technical Problem

The present invention provides a method for manufacturing granulated bentonite to improve a separation phenomenon and enhance a peptization property.

The present invention also provides a method for manufacturing granulated bentonite which can be used as a grout material, wherein bentonite, sand, alumina, graphite and the like are mixed in advance and formed as a molded body.

In addition, the present invention provides a method for manufacturing granulated bentonite which can be applied in various applications such as geothermal field.

### Technical Solution

In one aspect, there is provided in the present invention a method for manufacturing granulated bentonite including mixing a raw material of bentonite with sand, alumina or graphite, heating the resulting mixture to 700-1,200° C., and grinding a molded body formed by heating to produce granules.

In another aspect, there is provided in the present invention granulated bentonite that is produced by the manufacturing method described above.

### Advantageous Effects

According to the present invention, since materials are mixed, followed by heating to produce an integrally molded body, separation phenomenon by which materials are separated from each other can be prevented and bentonite granules having good peptization property can be provided.

Furthermore, since a layer separation hardly occurs, effects such as good compatibility and convenient construction can be obtained when such granulated bentonite is used in a grouting process.

### BRIEF DESCRIPTION OF THE DRAWINGS

FIG. 1 is a flow chart illustrating the method for manufacturing granulated bentonite molded body according to the present invention.

FIG. 2 illustrates photographic images comparing particle sizes of the granulated bentonite of the present invention according to the degree of grinding, the left image being bentonite after a heat-treatment process, the central image being coarsely ground granules, and the right image being finely ground granules.

FIG. 3 illustrates photographic images showing a peptization property of the granulated bentonite over time according to the present invention.

FIG. 4 illustrates photographic images showing a layer separation in a composition of the granulated bentonite according to present invention and a conventional bentonite mixed with sand.

### BEST MODE FOR CARRYING OUT THE INVENTION

Hereinafter, the present invention will be described in detail.

A method for manufacturing granulated bentonite according to the present invention includes a process of adding at least any one of sand, alumina and graphite to a raw material of bentonite and mixing (S10), a heat-treatment process of heating the resulting mixture to 700 to 1,200° C. (S20), and a process of grinding a molded body formed by heating to produce granules (S30).

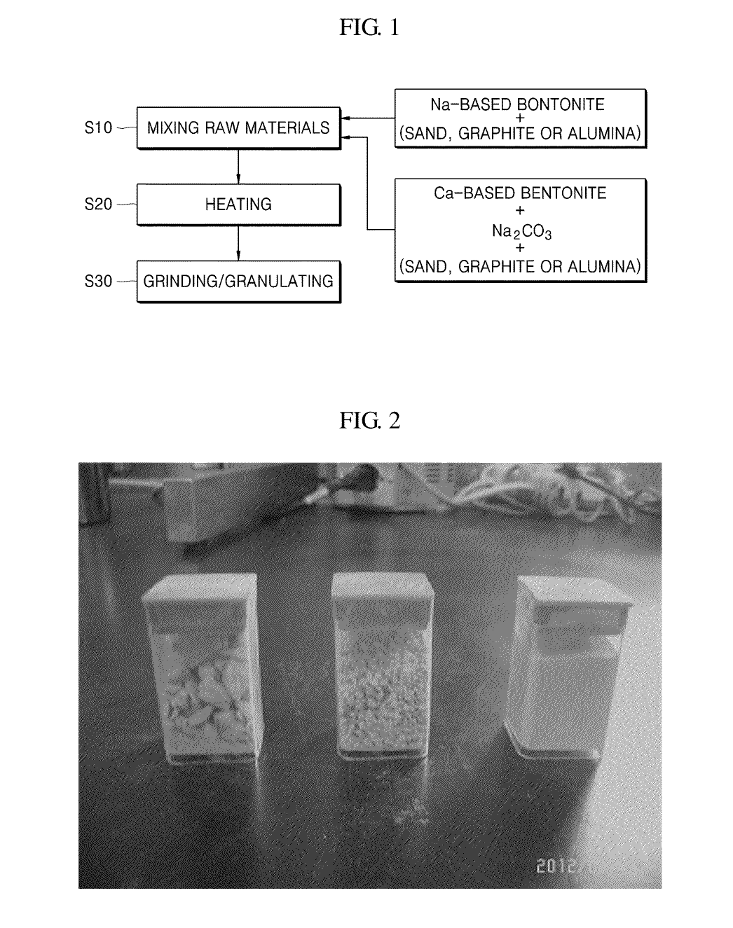

Referring to FIG. 1, various raw materials are firstly prepared, and the raw materials are mixed in a desired ratio (S10). As the raw material of bentonite, Na-based bentonite may be used, or a raw material obtained by mixing Ca-based bentonite with Na₂CO₃ and activating by heat-treatment may be used. That is, the Ca-based bentonite may be used after preparing as the Na-based bentonite. Also, in the mixing process, the Ca-based bentonite is mixed with Na₂CO₃, and then, sand, alumina or graphite may be further mixed. That is, the Ca-based bentonite may be converted into the Na-based bentonite while heating with other components such as sand by the heat-treatment, as will be described below.

In addition, as used herein, bentonite is a type of natural clay and is swelled by 10-20 times its original volume upon contacting water and contracted to its original volume upon eliminating water and drying. Due to gellation and swellability by water, bentonite is currently used as a waterproof material in most of large scale civil ground works such as underground construction work. Such bentonite includes montmorillonite as a primary component, and may be roughly divided into Na-based bentonite and Ca-based bentonite depending on a predominant cation among cations such as Na⁺ and Ca²⁺ present between lamella structures of the montmorillonite in the bentonite. Although Ca-based bentonite is primarily found in nature, cations of the Ca-based bentonite are replaced with Na to obtain the Na-based bentonite since the Na-based bentonite has superior viscosity and swellability relative to the Ca-based bentonite. Specifically, the Ca-based bentonite is mined, ground, mixed with a Na₂CO₃ powder, and subjected to heat-treatment at 700-1,200° C. to produce the Na-based bentonite. This procedure is called as an activation process. During the activation process, a mixture may be added, heat-treated together and granulated. In the activation process, before heating, sand, alumina or graphite may be further added.

In addition, the particle size of the bentonite raw material is determined according to the grinding degree of raw ore, and a small particle size is preferred for effectiveness of the activation process. The particle size is not particularly limited, but the powder of bentonite having an average particle size of 1 to 1,000 μm may be preferably used.

Sand, alumina, graphite or the like is an aid that is added to increase thermal conductivity. These aids may be integrated in a molded body by heat-treatment, as will be described below. As such aids, any one of sand, alumina and graphite may be used, or otherwise a combination of two or more aids may be used. That is, aids may be adjusted in their type and content according to the desired thermal conductivity, and then added to the bentonite raw material.

These aids may be mixed in an amount of 10 wt % to 1,000 wt % with respect to the weight of the bentonite raw material. That is, the content of at least one aid among the aids may be 10 wt % to 1,000 wt %. Alternatively, when multiple aids are used, the sum of each aid used may be 10 wt % to 1,000 wt %. For example, when both of alumina and sand are used as an aid, each of alumina and sand may be 5 wt % to 500 wt % with respect to the weight of the bentonite raw material. If the content of an aid such as sand, alumina or graphite exceeds the above-mentioned range, a layer separation phenomenon may severely occur. If the content of an aid such as sand, alumina or graphite is less than the above-mentioned range, thermal conductivity may not be sufficiently increased. Also, a mixing ratio may be adjusted within the above-mentioned range according to the desired thermal conductivity and water-blocking ability of the bentonite raw material.

Herein, sand is not particularly limited, but sand having an average particle diameter of 10 to 1,000 μm may be preferably used. If the average particle diameter of sand is less than 10 μm, an effect of increasing thermal conductivity may be reduced. If the average particle diameter of sand is greater than 1,000 μm, severe sedimentation may occur due to a difference in specific gravity and consequently bentonite and sand may be separated.

Alumina is used to increase the thermal conductivity of a bentonite molded body according to the present invention. Alumina is not particularly limited, but alumina having an average particle diameter of 10 to 1,000 μm may be preferably used. If the average particle diameter of sand is greater than 1,000 μm, severe sedimentation may occur due to a difference in specific gravity and consequently bentonite and alumina may be separated.

Graphite may be also used to increase the thermal conductivity of a bentonite molded body according to the present invention, and is not particularly limited in its type and size.

Next, a mixture of various components mixed in a desired ratio is heated to a desired temperature range (S20). That is, the mixture is placed in a heating device such as heating furnace and heated to a temperature range of 700 to 1,200° C. until each component is sufficiently sintered.

As described above, sand, alumina or graphite is further added to bentonite, and then the resulting mixture is heated in a heating device. The heating device for heating is not particularly limited as long as it is commonly used in the art. The heating temperature for heating is preferably in the range of 700 to 1,200° C. If the heating temperature is less than 700° C., the mixture may not be sufficiently sintered and the resulting granulated bentonite may not have sufficient hardness or bonding strength. If the temperature is greater than 1,200° C., the mixture may be excessively sintered and consequently it may be difficult to apply in a grouting process.

When the mixture is heated using the heating device, the bentonite raw material and an aid including sand, graphite or alumina are together sintered and formed as an integrally sintered molded body. That is, a molded body with bentonite being strongly bonded with the aid can be obtained. The molded body thus produced can be prevented from being separated as individual materials or components when it is used in a variety of applications. Also, the molded body thus produced is little peptized when it is wetted by water.

Furthermore, in the case that a Ca-based bentonite raw material and Na₂CO₃ as well as an aid component (sand, graphite or alumina) are together mixed and subjected to heat-treatment, these materials are reacted to form Na-based bentonite.

Next, the sintered molded body is ground to produce granules of uniform sizes (S30). That is, the sintered molded body is ground by a grinder to form a uniformly granulated bentonite molded body. The grinder is not particularly limited, and a desired sized-granulated bentonite molded body can be obtained by controlling grinding rate and grinding time period appropriately. The diameter of the granulated bentonite molded body is not particularly limited, but specifically an average diameter may be 1 to 10 mm, and 1 to 5 mm. It is suitable for injecting a grouting material mixed with water in a hole. If the size is less than 1 mm, an effect of increasing thermal conductivity may be reduced. If the size is greater than 10 mm, workability of injecting in a hole may be reduced.

The present invention provides a bentonite molded body manufactured by the method for manufacturing granulated bentonite as described above.

Hereinafter, the present invention will be described in detail with reference to Examples and Experimental examples. These examples are described only for illustration, but are not intended to limit the scope of the present invention.

### MODE FOR CARRYING OUT THE INVENTION

### EXAMPLE 1

To a 200 ml beaker, 50 g of a dry raw material of Na-based bentonite (High TC Geothermal Grout made by CETCO (USA)) and 10 g of sand were filled, 100 g of water was added, and the resulting mixture was stirred for 10 min. After the bentonite mixture was fully dried in a drier (120° C.), the mixture was placed in a heating furnace (AZEN H-1200 Model) and heat-treated at 800° C. for 1 h. Then, the mixture was coarsely ground in a mortar and passed through a 10 mesh sieve to obtain granulated bentonite of about 2 mm diameter. That is, as shown in FIG. 2, a left photographic image shows a bentonite molded body that is not ground immediately after heat-treatment, and a central photographic image shows a bentonite molded body that is ground into about 2 mm particle diameter, which is the granulated bentonite molded body obtained in Example 1. A powder may be obtained by further finely grinding the molded body. For example, in FIG. 2, a right photographic image shows a bentonite molded body that is fully ground as a powder, which is commercially marketed.

### COMPARATIVE EXAMPLE 1

To a 200 ml beaker, 50 g of a dry raw material of Na-based bentonite (High TC Geothermal Grout made by CETCO (USA)) and 10 g of sand were filled, 100 g of water was added, and the resulting mixture was stirred for 10 min. The bentonite mixture was used as Comparative example 1.

### EXPERIMENTAL EXAMPLE 1

### Peptization

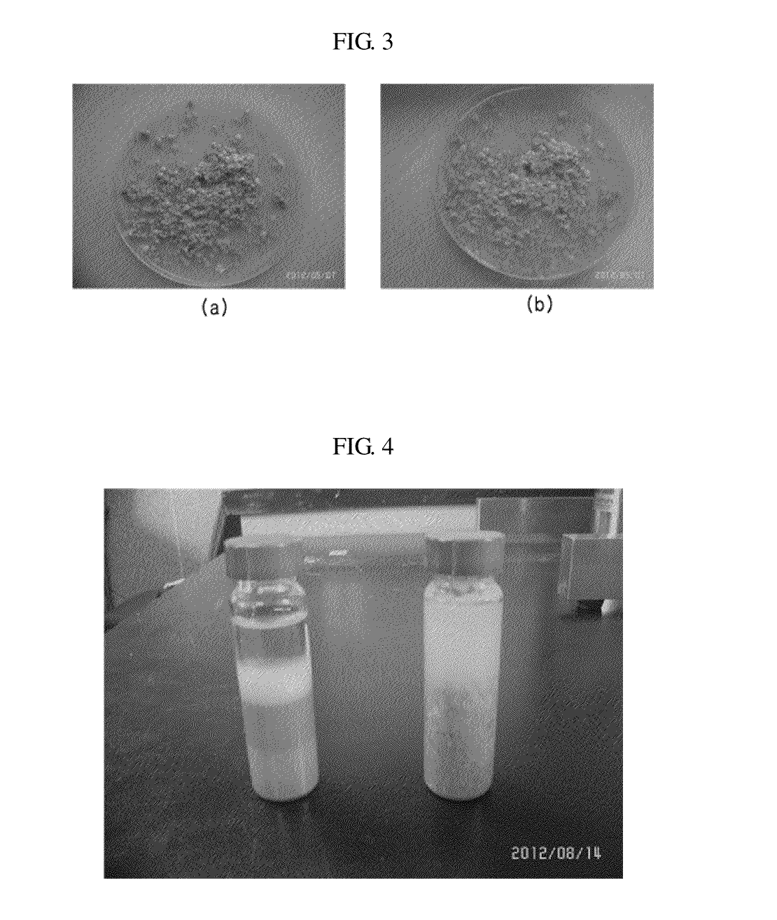

Peptization was observed using the granulated bentonite manufactured in Example 1. FIG. 3 illustrates photographic images showing a peptization property over time of the granulated bentonite according to the present invention.

In FIG. 3 that illustrates a peptization property over time of the granulated bentonite according to the present invention, FIG. 3(a) is taken immediately after immersing in water and stirring, and FIG. 3(b) is taken at 8 h after immersing in water and stirring. Both show little difference. That is, peptization was not observed over a long time after stirring and a state similar to an initial state was maintained. From this observation, it can be seen that the granulated bentonite molded body of Example 1 has no difference in peptization over time.

### EXPERIMENTAL EXAMPLE 2

### Layer Separation

FIG. 4 illustrates a layer separation phenomenon of the granulated bentonite manufactured in Example 1 (right side) and the bentonite mixture of Comparative example 1 (left side). As seen in the right side, the granulated bentonite of Example 1 is uniformly mixed with no layer separation. In contrast, as seen in the left side, the bentonite mixture of Comparative example 1 shows a layer separation due to a difference in density. Thus, it can be seen that the granulated bentonite of Example 1 can be maintained in a constant state without separation as individual components compared to a conventional bentonite mixture.

### INDUSTRIAL APPLICABILITY

The present invention can provide a bentonite molded body having good peptization property and good compatibility without a layer separation phenomenon. The bentonite molded body according to the present invention can be used in a simple grouting process.

Further, a grouting material using the bentonite molded body according to the present invention having good compatibility and convenient workability can be used in fields requiring high thermal conductivity such as a geothermal heat exchanger.

1. A method for manufacturing granulated bentonite molded body, comprising:
mixing a raw material of bentonite with at least any one of sand, alumina and graphite as an aid;
heating the resulting mixture to 700-1,200° C.; and
grinding a molded body formed by heating to produce granules.

2. The method for manufacturing granulated bentonite molded body of claim 1, wherein Na-based bentonite, or a raw material obtained by mixing Ca-based bentonite with Na₂CO₃ and activating by heat-treatment is used as the raw material of bentonite.

3. The method for manufacturing granulated bentonite molded body of claim 1, wherein the mixing further comprises mixing a Ca-based bentonite raw material with Na₂CO₃ and adding sand, graphite or alumina.

4. The method for manufacturing granulated bentonite molded body of claim 1, wherein the alumina has an average particle diameter in a range of 10 to 1,000 μm.

5. The method for manufacturing granulated bentonite molded body of claim 1, wherein the sand has an average particle diameter in a range of 10 to 1,000 μm.

6. The method for manufacturing granulated bentonite molded body of claim 1, wherein the granules have an average diameter in a range of 1 to 10 mm.

7. The method for manufacturing granulated bentonite molded body of claim 1, wherein the aid is mixed in an amount of 10 wt % to 1,000 wt % with respect to the weight of the bentonite raw material.

8. A granulated bentonite molded body manufactured by the method according to claim 1.
